(19) United States
(12) Patent Application Publication
(10) Pub. No.: US 2014/0354480 A1
(43) Pub. Date: Dec. 4, 2014

(54) APPARATUS FOR WIRELESS COMMUNICATION

(71) Applicants: Antti Paavo Tapani Kainulainen, Espoo (FI); Kimmo Kalliola, Espoo (FI); Ping Hui, Richmond (CA)

(72) Inventors: Antti Paavo Tapani Kainulainen, Espoo (FI); Kimmo Kalliola, Espoo (FI); Ping Hui, Richmond (CA)

(73) Assignee: NOKIA CORPORATION, Espoo (FI)

(21) Appl. No.: 14/355,660

(22) PCT Filed: Nov. 4, 2011
(86) PCT No.: PCT/IB2011/054937

§ 371 Date: Jul. 24, 2014

(51) Int. Cl. G01S 1/02

(52) U.S. Cl. CPC G01S 1/02
USPC 342/385; 29/600

(57) ABSTRACT

An apparatus comprising: radio frequency circuitry; an electrical energy storage device configured to provide electrical energy to the radio frequency circuitry; and an antenna configured to receive signals from the radio frequency circuitry and comprising a first antenna portion and a second antenna portion, the first antenna portion and the second antenna portion being oriented in different directions, the antenna being configured to transmit signals received from the radio frequency circuitry to enable a hand portable device to determine a location of the apparatus from the transmitted signals.

### TECHNOLOGICAL FIELD

Embodiments of the present invention relate to apparatus for wireless communication. In particular, some embodiments relate to apparatus in the field of sports equipment.

### BACKGROUND

Apparatus, such as sports equipment and hand portable communication devices, may be carried by a user and taken to various locations. For example, a user may take several golf balls from their house to a golf course to play a round of golf. By way of another example, a user may carry their mobile cellular telephone in a trouser pocket to work or a leisure activity.

Due to the portability of such apparatus, there is a possibility that the apparatus may fall from the user, or be misplaced by the user, and become lost. Furthermore, where the apparatus (such as sports equipment) is used in an activity, there is a possibility that the apparatus may become lost during the activity.

It would therefore be desirable to provide an alternative apparatus.

### BRIEF SUMMARY

According to various, but not necessarily all, embodiments of the invention there is provided an apparatus comprising: radio frequency circuitry; an electrical energy storage device configured to provide electrical energy to the radio frequency circuitry; and an antenna configured to receive signals from the radio frequency circuitry and comprising a first antenna portion and a second antenna portion, the first antenna portion and the second antenna portion being oriented in different directions, the antenna being configured to transmit signals received from the radio frequency circuitry to enable a hand portable device to determine a location of the apparatus from the transmitted signals.

The first antenna portion and the second antenna portion may be arranged orthogonally relative to one another.

The radio frequency circuitry may be configured to provide a signal to the antenna without requiring a preceding signal received at the antenna.

The apparatus may further comprise a housing, the radio frequency circuitry, the electrical energy storage device and the antenna being housed by the housing.

The first antenna portion and the second antenna portion may be connected to the radio frequency circuitry via a switch. The switch may have at least a first electrical configuration in which the first antenna portion is connected to the radio frequency circuitry, and a second electrical configuration in which the second antenna portion is connected to the radio frequency circuitry.

The apparatus may further comprise a sensor configured to sense the orientation of the apparatus, and a processor configured to receive the sensed orientation from the sensor and to control the switch to switch to the first electrical configuration or to the second electrical configuration depending upon the sensed orientation.

The first antenna portion and the second antenna portion may be galvanically isolated from one another. The radio frequency circuitry may be connected to the first antenna portion and not connected to the second antenna portion.

The second antenna portion may be configured to parasitically couple to the first antenna portion.

The first antenna portion and the second antenna portion may be galvanically connected to one another.

The apparatus may further comprise a sensor configured to sense acceleration of the apparatus, and a processor configured to receive the sensed acceleration and to determine if the sensed acceleration exceeds a predetermined threshold, wherein if the acceleration exceeds a predetermined threshold, the processor is configured to control the electrical energy storage device to provide electrical energy to the radio frequency circuitry.

According to various, but not necessarily all, embodiments of the invention there is provided a portable electronic device comprising an apparatus as described in any of the preceding paragraphs.

According to various, but not necessarily all, embodiments of the invention there is provided sports equipment comprising an apparatus as described in any of the preceding paragraphs.

The sports equipment may be at least one of a sports ball, a ski, a snowboard, a sports racket, a sports bat, an oar, a paddle, an item of sailing equipment, an item of survival equipment, a bag, and a compass.

According to various, but not necessarily all, embodiments of the invention there is provided a module comprising an apparatus as described in any of the preceding paragraphs.

According to various, but not necessarily all, embodiments of the invention there is provided a method comprising: forming an apparatus by: providing radio frequency circuitry; providing an electrical energy storage device configured to provide electrical energy to the radio frequency circuitry; and providing an antenna configured to receive signals from the radio frequency circuitry and comprising a first antenna portion and a second antenna portion, the first antenna portion and the second antenna portion being oriented in different directions, the antenna being configured to transmit signals received from the radio frequency circuitry to enable a hand portable device to determine a location of the apparatus from the transmitted signals.

The first antenna portion and the second antenna portion may be arranged orthogonally relative to one another.

The radio frequency circuitry may be configured to provide a signal to the antenna without requiring a preceding signal received at the antenna.

The method may further comprise providing a housing, the radio frequency circuitry, the electrical energy storage device and the antenna being housed by the housing.

The first antenna portion and the second antenna portion may be connected to the radio frequency circuitry via a switch. The switch may have at least a first electrical configuration in which the first antenna portion is connected to the radio frequency circuitry, and a second electrical configuration in which the second antenna portion is connected to the radio frequency circuitry.

The method may further comprise providing a sensor configured to sense the orientation of the apparatus, and a processor configured to receive the sensed orientation from the sensor and to control the switch to switch to the first electrical configuration or to the second electrical configuration depending upon the sensed orientation.

The first antenna portion and the second antenna portion may be galvanically isolated from one another. The radio frequency circuitry may be connected to the first antenna portion and not connected to the second antenna portion.

The second antenna portion may be configured to parasitically couple to the first antenna portion.

The first antenna portion and the second antenna portion may be galvanically connected to one another.

The method may further comprise providing a sensor configured to sense acceleration of the apparatus, and a processor configured to receive the sensed acceleration and to determine if the sensed acceleration exceeds a predetermined threshold, wherein if the acceleration exceeds a predetermined threshold, the processor is configured to control the electrical energy storage device to provide electrical energy to the radio frequency circuitry.

### BRIEF DESCRIPTION

For a better understanding of various examples of embodiments of the present invention reference will now be made by way of example only to the accompanying drawings in which:

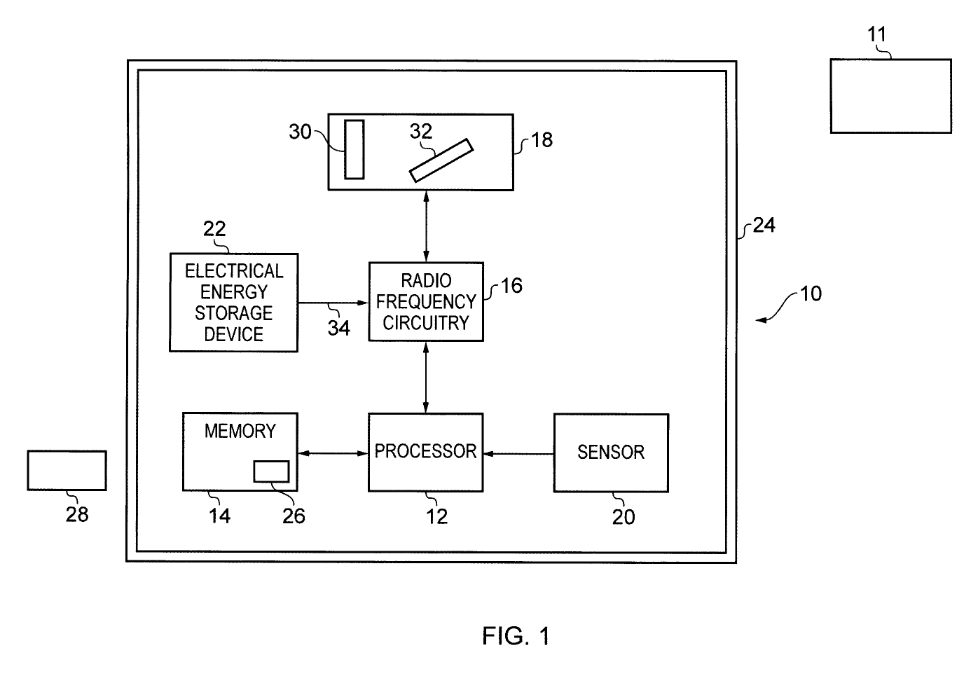

FIG. 1 illustrates a schematic diagram of an apparatus according to various embodiments of the invention;

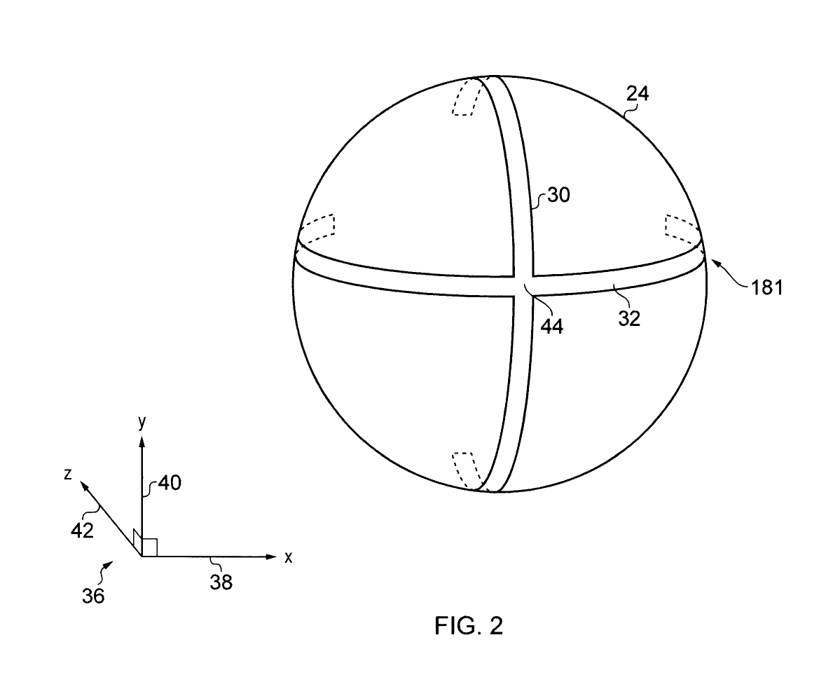

FIG. 2 illustrates a perspective view of an antenna according to various embodiments of the invention;

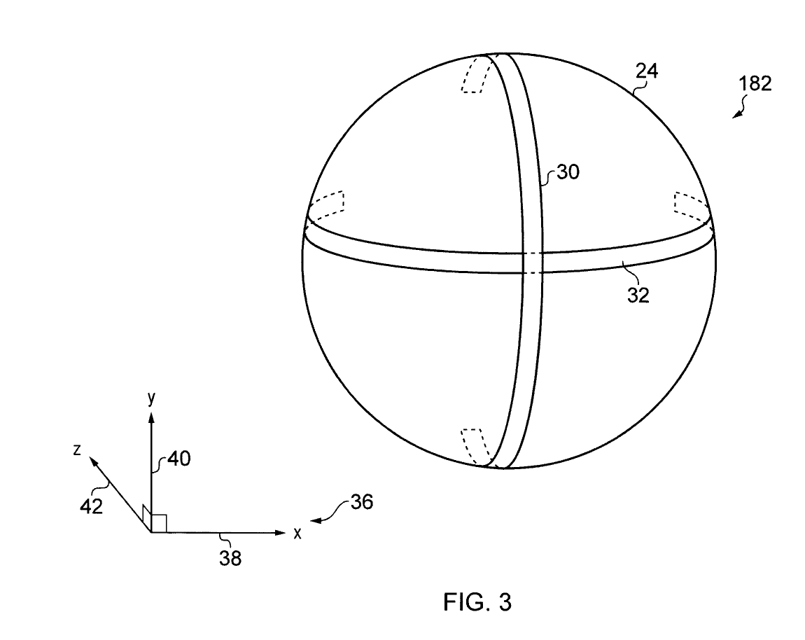

FIG. 3 illustrates a perspective view of another antenna according to various embodiments of the invention;

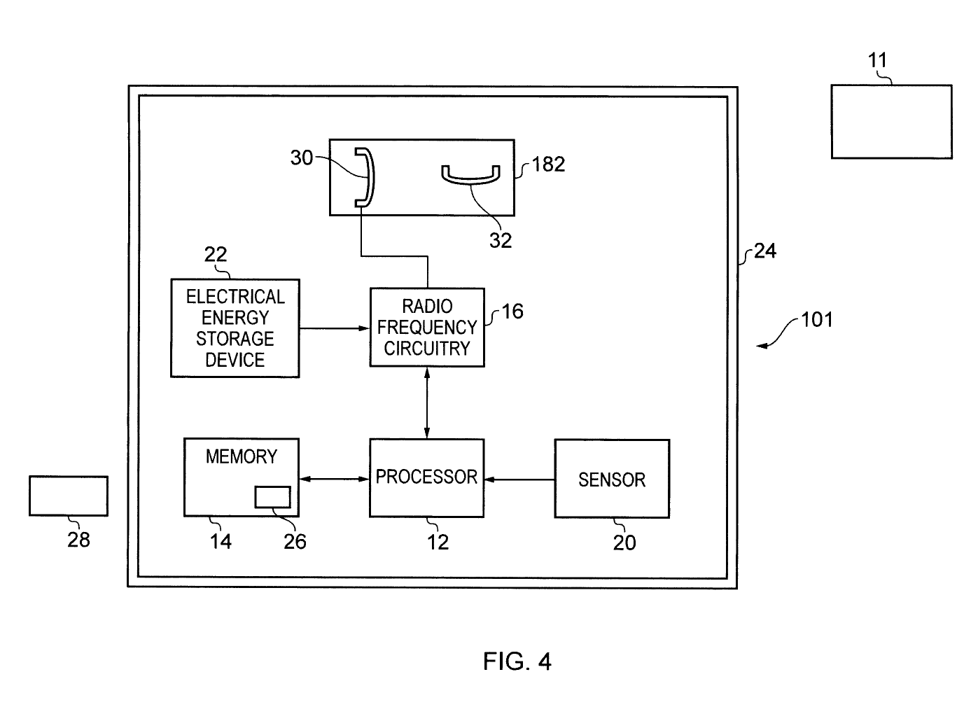

FIG. 4 illustrates a schematic diagram of another apparatus according to various embodiments of the invention;

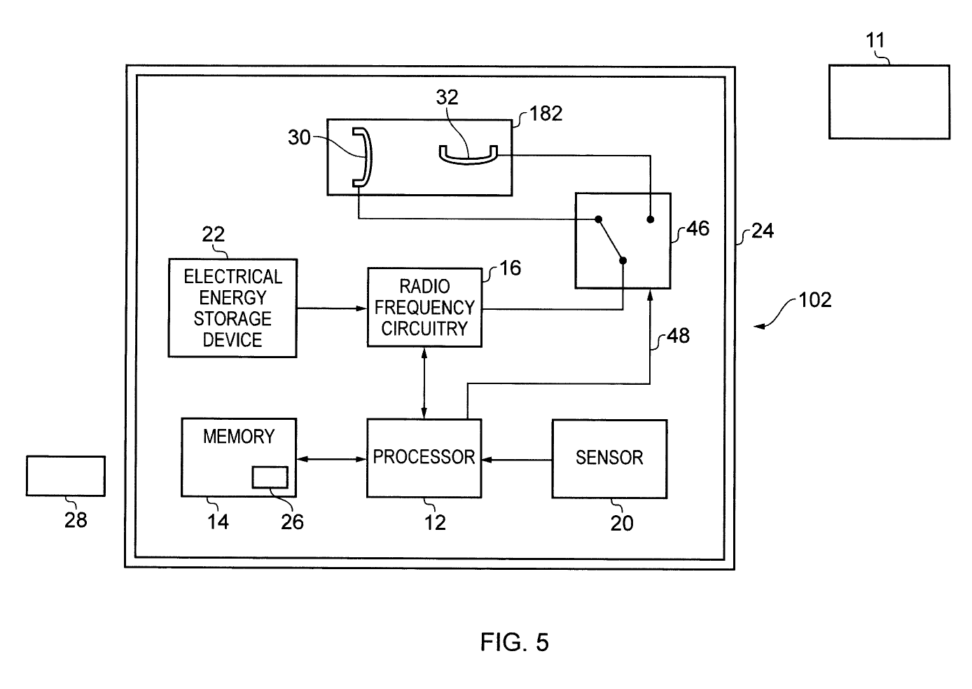

FIG. 5 illustrates a schematic diagram of a further apparatus according to various embodiments of the invention;

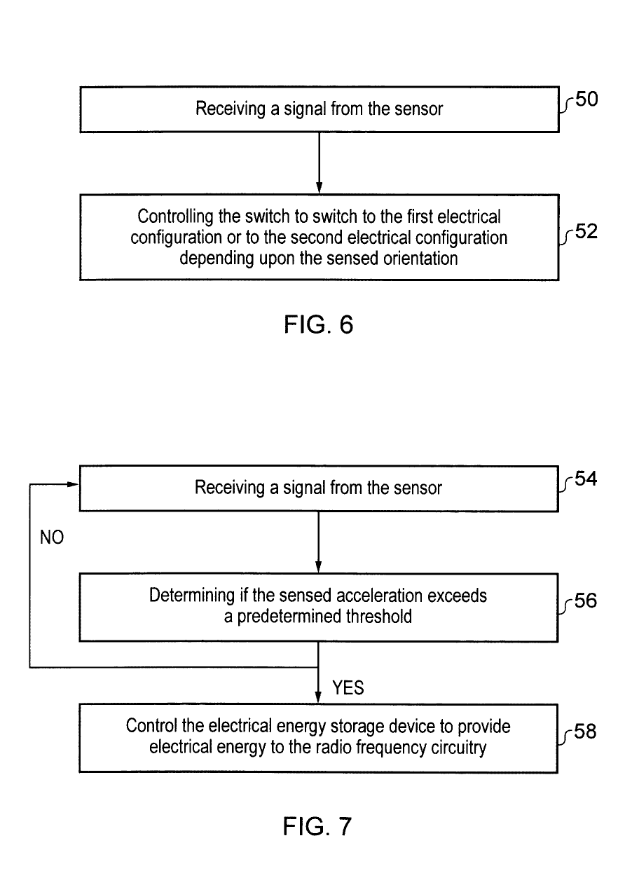

FIG. 6 illustrates a flow diagram of a method according to various embodiments of the invention;

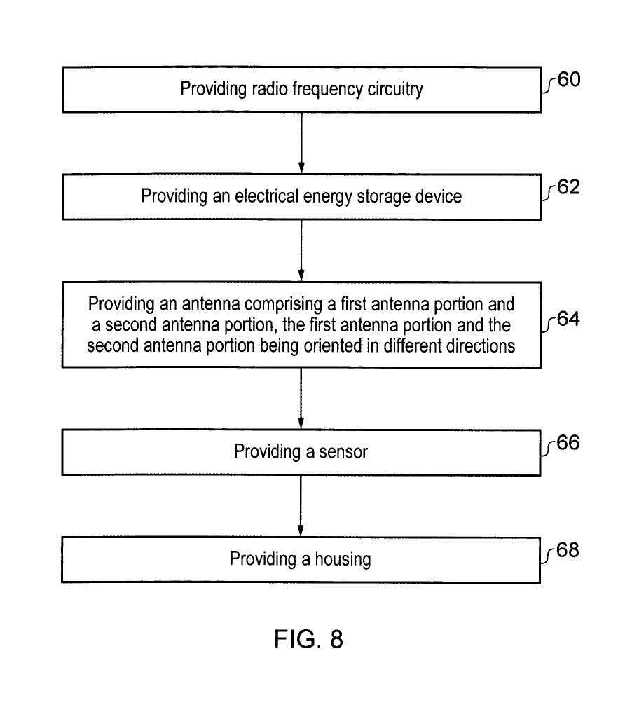

FIG. 7 illustrates a flow diagram of another method according to various embodiments of the invention; and

FIG. 8 illustrates a flow diagram of a method of forming an apparatus according to various embodiments of the invention.

### DETAILED DESCRIPTION

In the following description, the wording ‘connect’ and ‘couple’ and their derivatives mean operationally connected or coupled. It should be appreciated that any number or combination of intervening components can exist (including no intervening components). Additionally, it should be appreciated that the connection or coupling may be a physical galvanic connection and/or an electromagnetic connection.

FIGS. 1, 4 and 5 illustrate an apparatus 10, 101, 102 comprising: radio frequency circuitry 16; an electrical energy storage device 22 configured to provide electrical energy to the radio frequency circuitry 16; and an antenna 18, 181, 182 configured to receive signals from the radio frequency circuitry 16 and comprising a first antenna portion 30 and a second antenna portion 32, the first antenna portion 30 and the second antenna portion 32 being oriented in different directions, the antenna 18, 181, 182 at least being configured to transmit signals received from the radio frequency circuitry 16 to enable a hand portable device 11 to determine a location of the apparatus 10, 101, 102 from the transmitted signals. In some embodiments the antenna 18, 181, 182 may also be configured to receive signals transmitted from the hand portable device 11.

In more detail, FIG. 1 illustrates an apparatus 10 according to various embodiments of the invention and a hand portable device 11. The apparatus 10 comprises one or more processors 12, one or more memories 14, radio frequency circuitry 16, one or more antennas 18, one or more sensors 20, an electrical energy storage device 22 and a housing 24.

The apparatus 10 may be any apparatus and may be a portable communication device (for example, a mobile cellular telephone, a tablet computer, a laptop computer, a personal digital assistant or a hand held computer), a portable multimedia device (for example, a music player, a video player, a game console and so on), sports equipment (such as a sports ball (for example, a golf ball, a tennis ball, a baseball or a football), a ski, a snowboard, a sports racket, a sports bat, an oar or a paddle), sailing equipment, survival equipment (such as a food container, a drinks container, a bag or a compass) or a module for such apparatus. As used here, ‘module’ refers to a unit or apparatus that excludes certain parts or components that would be added by an end manufacturer or a user.

It should be appreciated that the apparatus 10 may include additional components in other embodiments. For example, where the apparatus 10 is a portable communication device such as a mobile cellular telephone, the apparatus 10 may additionally include a display, a user input device, an audio input device and an audio output device.

The implementation of the processor 12 can be in hardware alone (a circuit for example), have certain aspects in software including firmware alone or can be a combination of hardware and software (including firmware). The processor 12 may be implemented using instructions that enable hardware functionality, for example, by using executable computer program instructions in a general-purpose or special-purpose processor that may be stored on a computer readable storage medium (disk, memory and so on) to be executed by such a processor.

The memory 14 may include any suitable memory and may include solid state memory for example. The processor 12 is configured to read from and write to the memory 14. The processor 12 may also comprise an output interface via which data and/or commands are output by the processor 12 and an input interface via which data and/or commands are input to the processor 12.

The memory 14 stores a computer program 26 comprising computer program instructions that control the operation of the apparatus 10 when loaded into the processor 12. The computer program instructions 26 provide the logic and routines that enables the apparatus 10 to perform the methods illustrated in FIGS. 6 and 7. The processor 12 by reading the memory 14 is able to load and execute the computer program 26.

The computer program 26 may arrive at the apparatus 10 via any suitable delivery mechanism 28. The delivery mechanism 28 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 26. The delivery mechanism may be a signal configured to reliably transfer the computer program 26. The apparatus 10 may propagate or transmit the computer program 26 as a computer data signal.

Although the memory 14 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ and so on, or a ‘controller’, ‘computer’, ‘processor’ and so on, should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code and so on should be understood to encompass software for a programmable processor or firmware such as, for example, the programmable content of a hardware device whether instructions for a processor, or configuration settings for a fixed-function device, gate array or programmable logic device and so on.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The radio frequency circuitry 16 is configured to receive signals from the processor 12, encode the signals, and provide the encoded signals to the antenna 18 for transmission. The radio frequency circuitry 16 may additionally be configured to receive signals from the antenna 18, decode the signals, and provide the decoded signals to the processor 12.

The antenna 18 and the radio frequency circuitry 16 may be configured to operate in one or more operational frequency bands and via one or more protocols. For example, the operational frequency bands and protocols may include (but are not limited to), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HiperLAN) (5150-5850 MHz); ultra wideband (UWB) Lower (3100-4900 MHz); UWB Upper (6000-10600 MHz); radio frequency identification ultra high frequency (RFID UHF) (433 MHz, 865-956 MHz, 2450 MHz).

A frequency band over which the antenna 18 can efficiently operate using a protocol is a frequency range where the return loss of the antenna 18 is greater than an operational threshold. For example, efficient operation may occur when the return loss of the antenna 18 is better than −4 dB or −6 dB.

The antenna 18 may include any suitable conductive material that enables the antenna 18 to radiate electromagnetic waves. For example, the antenna 18 may include a metal such as copper. Where the apparatus 10 is likely to experience significant acceleration (for example, where the apparatus 10 is a sports ball), the antenna 18 may comprise an elastic conductive material such as a cured conductive ink for example.

The antenna 18 includes a first antenna portion 30 and a second antenna portion 32. The first antenna portion 30 includes at least a part that is oriented in a different direction to at least a part of the second antenna portion 32. In various embodiments, the first antenna portion 30 and the second antenna portion 32 are oriented orthogonally relative to one another (that is, the first antenna portion 30 includes at least a part that is perpendicular to at least a part of the second antenna portion 32). In other embodiments, the first antenna portion 30 and the second antenna portion 32 may define any angle there between and may be oriented at forty five degrees to one another as illustrated in FIG. 1 for example.

It should be appreciated that since the first antenna portion 30 and the second antenna portion 32 are oriented in different directions they are able to transmit and receive electromagnetic waves having different polarization angles. In more detail, the first antenna portion 30 is able to transmit electromagnetic waves that are polarized in a direction that is parallel to the orientation of the first antenna portion 30 and the second antenna portion 32 is able to transmit electromagnetic waves that are polarized in a direction that is parallel to the orientation of the second antenna portion 32.

The sensor 20 may be any suitable sensor that is configured to sense the orientation of the apparatus 10 and/or the acceleration of the apparatus 10 and provide these sensed parameters to the processor 12. For example, the sensor 20 may include an accelerometer and/or a gyroscope.

The electrical energy storage device 22 may be any suitable device for storing and supplying electrical energy. For example, the electrical energy storage device 22 may include one or more electrochemical cells and/or one or more electric double layer capacitors (which may also be referred to as a ‘supercapacitor’). The electrical energy storage device 22 is configured to supply electrical energy to the components of the apparatus 10 to enable them to function. For example, the electrical energy storage device 22 is configured to supply electrical energy to the radio frequency circuitry 16 (as indicated by arrow 34) to enable the radio frequency circuitry 16 to function.

The housing 24 is configured to house the components of the apparatus 10 and protect them from being damaged or destroyed. For example, the housing 24 may house the processor 12, the memory 14, the radio frequency circuitry 16, the antenna 18, the sensor 20 and the electrical energy storage device 22. In embodiments where the apparatus 10 is a portable communication device such as a mobile cellular telephone, the housing 24 is the exterior cover of the device that is visible to the user. In embodiments where the apparatus 10 is a golf ball, the housing 24 may include the inner core of the golf ball on which the components of the apparatus 10 are mounted, and also include the exterior surface of the golf ball that covers the components of the apparatus 10.

The hand portable device 11 may be any hand portable device and may be a portable communication device such as a mobile cellular telephone for example. The hand portable device 11 may include one or more processors, one or more memories, radio frequency circuitry, an antenna array, and an output device (such as a display and/or a loudspeaker).

The hand portable device 11 is configured to receive a signal transmitted from the antenna 18 at the antenna array and to determine the direction and the distance of the apparatus 10 from the hand portable device 11 at the processor. The processor may then control the output device to present the direction and distance information to the user of the hand portable device 11. For example, the processor may control a display to display a graphical user interface that includes an image of the direction and distance of the apparatus 10. By way of another example, the processor may control a loudspeaker to output acoustic waves that inform the user of the direction and distance of the apparatus 10. Consequently, the apparatus 10 and the hand portable device 11 may be viewed as a radar system where the hand portable device 11 is configured to track the direction and distance of the apparatus 10.

In some embodiments, the apparatus 10 and the hand portable device 11 are configured to communicate via Bluetooth and the antenna array of the hand portable device 11 includes at least three antennas. In these embodiments, the processor of the hand portable device 11 is configured to determine the direction of arrival of the signal transmitted by the apparatus 10 by measuring the relative phases and amplitudes of the signals received at each of the antennas of the antenna array.

Various embodiments of the invention provide an advantage in that since the first and second antenna portions 30, 32 are oriented in different directions, the first and second antenna portions 30, 32 are able to transmit electromagnetic waves having different polarization angles. This is advantageous because if, for example, the first antenna portion 30 is oriented parallel to the surface of the Earth, the first antenna portion 30 is substantially short circuited and the electromagnetic wave to be transmitted cannot be radiated and propagated outwards. However, since the second antenna portion 32 is oriented in a different direction to the first antenna portion 30, the second antenna portion 32 may not be short circuited by the Earth and the electromagnetic wave to be transmitted can be radiated and propagated outwards. The second antenna portion 32 may be substantially perpendicular to the Earth's surface or ground.

Various embodiments of the invention also provide an advantage in that since the apparatus 10 includes an electrical energy storage device 22 that is configured to supply electrical energy to the radio frequency circuitry 16, the apparatus 10 may not require a preceding signal received at the antenna 18 in order to transmit a signal. This may advantageously enable the direction and distance to be determined by a hand portable device 11 that includes no ability to transmit a radio frequency signal (that is, a hand portable device 11 that only includes a receiver may determine the direction and distance of the apparatus 10).

Various embodiments of the invention additionally provide an advantage in that since the apparatus 10 is able to transmit electromagnetic waves that may be continuously received by the hand portable device 11, the hand portable device 11 may be configured to dynamically present the real time distance and direction of the apparatus 10 from the hand portable device 11. This may be particularly advantageous where the apparatus 10 is sports equipment since it may enable the hand portable device 11 to track the changing position and direction of the apparatus over time and this may be used to improve a user's use of the sports equipment. For example, where the apparatus 10 is a golf ball, embodiments of the invention may enable a user to view the trajectory of the golf ball through the air on the hand portable device 11 and then provide suggestions to the golfer in order to improve his swing. Embodiments of the invention may also advantageously enable the user of the hand portable device 11 to determine the position and direction of the golf ball 10 once it has landed on the ground.

Embodiments of the invention may also advantageously enable a user of a hand portable device 11, where the hand portable device is a mobile phone or similar device capable of communication with a base station or network router, so that a further hand portable device does not need to be carried, since the user of the hand portable device is most likely already carrying such a device on his/her person.

FIG. 2 illustrates a perspective view of an antenna 181 according to various embodiments of the invention and a Cartesian co-ordinate system 36. The Cartesian co-ordinate system 36 includes an x axis 38, a y axis 40 and a z axis 42 that are orthogonal to one another.

The antenna 181 is mounted on the outer surface of an inner core 24 of a sports ball (such as a golf ball) that is spherical in shape. The first antenna portion 30 and the second antenna portion 32 are galvanically connected to one another at an intersecting point 44 and define a cross shape.

The first antenna portion 30 extends around a perimeter of the inner core 24 in the y axis 40 and the z axis 42 directions. The first antenna portion 30 has two open ends and consequently does not extend fully around the perimeter of the inner core 24. The second antenna portion 32 extends around a perimeter of the inner core 24 in the x axis 38 and the z axis 42 directions. The second antenna portion 32 also has two open ends and consequently does not extend fully around the perimeter of the inner core 24.

The antenna 181 provides an advantage in that since the first antenna portion 30 and the second portion 32 are galvanically connected, the first antenna portion 30 transmits electromagnetic waves at the same time as the second antenna portion 32.

FIG. 3 illustrates a perspective view of another antenna 182 according to various embodiments of the invention and the Cartesian co-ordinate system 36. The antenna 182 is similar to the antenna 181 and where the features are similar, the same reference numerals are used. The antenna 182 differs from the antenna 181 in that the first antenna portion 30 is not galvanically connected to the second antenna portion 32 and is therefore galvanically isolated from the second antenna portion 32.

FIG. 4 illustrates a schematic diagram of another apparatus 101 according to various embodiments of the invention. The apparatus 101 is similar to the apparatus 10 illustrated in FIG. 1 and where the features are similar, the same reference numerals are used.

The apparatus 101 differs from the apparatus 10 in that it comprises the antenna 182 illustrated in FIG. 3. In this embodiment, the radio frequency circuitry 16 is connected to the first antenna portion 30, but is not connected to the second antenna portion 32. In some embodiments, the second antenna portion 32 may be connected to a ground member (not illustrated) and in other embodiments, the second antenna portion 32 may not be connected to a ground member and may therefore be a ‘floating’ parasitic element. The second antenna portion 32 is positioned relative to the first antenna portion 30 so that it parasitically couples to the first antenna portion 30. Consequently, the apparatus 101 is able to transmit electromagnetic waves from both the first antenna portion 30 and from the second antenna portion 32.

FIG. 5 illustrates a schematic diagram of a further apparatus 102 according to various embodiments of the invention. The apparatus 102 is similar to the apparatus 10 illustrated in FIG. 1 and where the features are similar, the same reference numerals are used.

The apparatus 102 differs from the apparatus 10 in that it comprises the antenna 182 illustrated in FIG. 3 and in that the radio frequency circuitry 16 is connected to the antenna 182 via a switch 46.

The switch 46 has a first electrical configuration and a second electrical configuration. When the switch 46 is in the first electrical configuration, the first antenna portion 30 is connected to the radio frequency circuitry 16 and the second antenna portion 32 is disconnected from the radio frequency circuitry 16. When the switch 46 is in the second electrical configuration, the second antenna portion 32 is connected to the radio frequency circuitry 16 and the first antenna portion 30 is disconnected from the radio frequency circuitry 16. The processor 46 is configured to provide a control signal 48 to the switch 46 to change the electrical configuration of the switch 46.

With reference to FIGS. 5 and 6, at block 50 the processor 12 may receive a signal from the sensor 20 and then process the signal to determine the orientation of the apparatus 102 relative to the Earth's surface. The processor 12 may then use the determined orientation of the apparatus 102 to determine which antenna portion of the first and second antenna portions 30, 32 is least parallel to the Earth's surface. For example, the processor 12 may determine the antenna portion by accessing a look up table stored in the memory 14 that sets out which antenna portion should be used for each orientation of the apparatus 102 relative to the Earth's surface (that is, the look up table specifies for each orientation of the apparatus 102, which antenna portion 30, 32 is least parallel to the Earth's surface).

At block 52, the processor 12 controls the switch 46 (via the control signal 48) to switch to the first electrical configuration or to the second electrical configuration depending upon which antenna portion 30, 32 is determined least parallel to the Earth's surface. For example, if the processor 12 determines that the first antenna portion 30 is least parallel to the Earth's surface, the processor 12 controls the switch 46 to switch to the first electrical configuration and thereby connect the first antenna portion 30 to the radio frequency circuitry 16. Similarly, if the processor 12 determines that the second antenna portion 32 is least parallel to the Earth's surface, the processor 12 controls the switch 46 to switch to the second electrical configuration and thereby connect the second antenna portion 32 to the radio frequency circuitry 16.

The apparatus 102 provides an advantage in that the processor 12 may dynamically select the antenna portion 30, 32 which is least parallel to the Earth's surface. This may advantageously result in the apparatus 102 consuming less electrical energy from the electrical energy storage device 22 since only a portion of the antenna 182 is used at any given time and radio frequency signals are directed only to the antenna portion which is able to provide the most efficient radiation of the antenna portions with respect to the Earth's surface.

FIG. 7 illustrates a flow diagram of a method according to various embodiments of the invention. The method illustrated in FIG. 7 may be performed by the apparatus 10, 101 and 102 where the sensor 20 is able to measure the acceleration of the apparatus 10, 101, 102.

At block 54, the method includes receiving a signal from the sensor 20 at the processor 12 that is indicative of the acceleration of the apparatus 10, 101, 102.

At block 56, the processor 12 compares the measured acceleration of the apparatus 10, 101, 102 against a predetermined threshold acceleration (stored in the memory 14 for example) and determines whether the measured acceleration exceeds the predetermined threshold acceleration.

If the measured acceleration does exceed the predetermined threshold acceleration, the method moves to block 58 and the processor 12 controls the electrical energy storage device 22 to provide electrical energy to the radio frequency circuitry 16 to enable the apparatus 10, 101, 102 to transmit electromagnetic waves. The processor 12 may control the electrical energy storage device 22 to not provide electrical energy to the radio frequency circuitry 16 if a predetermined period of time has expired (for example, several hours or several days).

If the measured acceleration does not exceed the predetermined threshold acceleration, the method returns to block 54 and the processor 12 awaits a signal from the sensor 20.

The method of FIG. 7 provides an advantage in that electromagnetic waves are transmitted from the apparatus 10, 101, 102 in response to the apparatus 10, 101, 102 experiencing an acceleration that exceeds a predetermined threshold acceleration. This may be particularly advantageous where the apparatus 10, 101, 102 is a sports ball and a user of the hand portable device 11 is interested in tracking the sports ball after it has been hit. This may also be advantageous where the apparatus 10, 101, 102 is a portable communication device such as a mobile cellular telephone and the user is interested in finding the device after it has been dropped (the impact with the ground providing the triggering acceleration).

If the apparatus 10, 101, 102 does not experience an acceleration that exceeds the predetermined threshold acceleration, the electrical energy storage device 22 may not supply electrical energy to the radio frequency circuitry 16 and this may help to reduce the electrical energy consumption of the apparatus 10, 101, 102.

FIG. 8 illustrates a flow diagram of a method of forming an apparatus 10, 101, 102 according to various embodiments of the invention.

At block 60, the method includes providing radio frequency circuitry 16.

At block 62, the method includes providing an electrical energy storage device 22.

At block 64, the method includes providing an antenna 18, 181, 182. The antenna 18, 181, 182 includes the first and second antenna portions 30, 32 that are oriented in different directions to one another.

At block 66, the method optionally includes providing a sensor 20, one or more processors 12 and one or more memories 14.

At block 68, the method optionally includes providing a housing 24 to house the components of the apparatus 10, 101, 102.

The blocks illustrated in the FIGS. 6, 7 and 8 may represent steps in a method and/or sections of code in a computer program. For example, the blocks illustrated in FIG. 8 may be executed by a processor to control machinery to manufacture an apparatus 10, 101, 102. The illustration of a particular order to the blocks does not necessarily imply that there is a required or preferred order for the blocks and the order and arrangement of the block may be varied. For example, blocks 60, 62, 64, 66 and 68 may be performed in any order. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, it should be appreciated that the antennas 18, 181, 182 may have any suitable shapes and the first and second antenna portions 30, 32 may define any angle there between. Furthermore, it should be appreciated that the antenna 18, 181, 182 may include any number of antenna portions. Furthermore, the switch 46 may have any number of electrical configurations so that any number of antenna portions may be connected to the radio frequency circuitry 16.

By way of another example, the apparatus 10, 101, 102 may be additionally configured to receive a transmitted signal from the hand portable device 11 and perform a function in response to aid a person in locating the apparatus 10, 101. 102.

For example, the apparatus 10, 101, 102 may comprise a light source (such as a light emitting diode) and may be configured to power on the light source in response to receiving a transmitted signal from the hand portable device 11. Where the apparatus 10, 101, 102 is sports equipment such as a golf ball, this embodiment may enable a golfer to visually identify the golf ball as he walks along the golf course.

In other embodiments, the apparatus 10, 101, 102 may include circuitry for providing an audio message in response to receiving a transmitted signal from the hand portable device 11. For example, the apparatus 10, 101, 102 may output an audio message that says “Hey, I'm over here!” in response to receiving a transmitted signal from the hand portable device 11.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-22. (canceled)

23. An apparatus comprising:
radio frequency circuitry;
an electrical energy storage device configured to provide electrical energy to the radio frequency circuitry; and
an antenna configured to receive signals from the radio frequency circuitry and comprising a first antenna portion and a second antenna portion, the first antenna portion and the second antenna portion being oriented in different directions, the antenna being configured to transmit signals received from the radio frequency circuitry to enable a hand portable device to determine a location of the apparatus from the transmitted signals,
wherein the first antenna portion and the second antenna portion are connected to the radio frequency circuitry via a switch, the switch having at least a first electrical configuration in which the first antenna portion is connected to the radio frequency circuitry, and a second electrical configuration in which the second antenna portion is connected to the radio frequency circuitry.

24. An apparatus as claimed in claim 23, wherein the first antenna portion and the second antenna portion are arranged orthogonally relative to one another.

25. An apparatus as claimed in claim 23, wherein the radio frequency circuitry is configured to provide a signal to the antenna without requiring a preceding signal received at the antenna.

26. An apparatus as claimed in claim 23, further comprising a housing, the radio frequency circuitry, the electrical energy storage device and the antenna being housed by the housing.

27. An apparatus as claimed in claim 23, further comprising a sensor configured to sense the orientation of the apparatus, and a processor configured to receive the sensed orientation from the sensor and to control the switch to switch to the first electrical configuration or to the second electrical configuration depending upon the sensed orientation.

28. An apparatus as claimed in claim 23, wherein the first antenna portion and the second antenna portion are galvanically isolated from one another, the radio frequency circuitry being connected to the first antenna portion and not connected to the second antenna portion, the second antenna portion being configured to parasitically couple to the first antenna portion.

29. An apparatus as claimed in claim 23, wherein the first antenna portion and the second antenna portion are galvanically connected to one another.

30. An apparatus as claimed in claim 23, further comprising a sensor configured to sense acceleration of the apparatus, and a processor configured to receive the sensed acceleration and to determine if the sensed acceleration exceeds a predetermined threshold, wherein if the acceleration exceeds a predetermined threshold, the processor is configured to control the electrical energy storage device to provide electrical energy to the radio frequency circuitry.

31. A portable electronic device comprising an apparatus as claimed in claim 23.

32. Sports equipment comprising an apparatus as claimed in claim 23.

33. Sports equipment as claimed in claim 32, wherein the sports equipment is at least one of a sports ball, a ski, a snowboard, a sports racket, a sports bat, an oar, a paddle, an item of sailing equipment, an item of survival equipment, a bag, and a compass.

34. A module comprising an apparatus as claimed in claim 23.

35. A method comprising:
forming an apparatus by:
providing radio frequency circuitry;
providing an electrical energy storage device configured to provide electrical energy to the radio frequency circuitry; and
providing an antenna configured to receive signals from the radio frequency circuitry and comprising a first antenna portion and a second antenna portion, the first antenna portion and the second antenna portion being oriented in different directions, the antenna being configured to transmit signals received from the radio frequency circuitry to enable a hand portable device to determine a location of the apparatus from the transmitted signals,
wherein the first antenna portion and the second antenna portion are connected to the radio frequency circuitry via a switch, the switch having at least a first electrical configuration in which the first antenna portion is connected to the radio frequency circuitry, and a second electrical configuration in which the second antenna portion is connected to the radio frequency circuitry.

36. A method as claimed in claim 35, wherein the first antenna portion and the second antenna portion are arranged orthogonally relative to one another.

37. A method as claimed in claim 35, wherein the radio frequency circuitry is configured to provide a signal to the antenna without requiring a preceding signal received at the antenna.

38. A method as claimed in claim 35, further comprising providing a housing, the radio frequency circuitry, the electrical energy storage device and the antenna being housed by the housing.

39. A method as claimed in claim 35, further comprising providing a sensor configured to sense the orientation of the apparatus, and a processor configured to receive the sensed orientation from the sensor and to control the switch to switch to the first electrical configuration or to the second electrical configuration depending upon the sensed orientation.

40. A method as claimed in claim 35, wherein the first antenna portion and the second antenna portion are galvanically isolated from one another, the radio frequency circuitry being connected to the first antenna portion and not connected to the second antenna portion, the second antenna portion being configured to parasitically couple to the first antenna portion.

41. A method as claimed in claim 35, wherein the first antenna portion and the second antenna portion are galvanically connected to one another.

42. A method as claimed in claim 35, further comprising providing a sensor configured to sense acceleration of the apparatus, and a processor configured to receive the sensed acceleration and to determine if the sensed acceleration exceeds a predetermined threshold, wherein if the acceleration exceeds a predetermined threshold, the processor is configured to control the electrical energy storage device to provide electrical energy to the radio frequency circuitry.
